(19) United States
(12) Patent Application Publication
(10) Pub. No.: US 2016/0188137 A1
(43) Pub. Date: Jun. 30, 2016

(54) METHOD AND SYSTEM FOR E-BOOK EXPRESSION RANDOMIZER AND INTERFACE THEREFOR

(71) Applicant: Kobo Incorporated, Toronto (CA)

(72) Inventors: Nora PARKER, Toronto (CA); Benjamin LANDAU, Toronto (CA)

(73) Assignee: Kobo Incorporated, Toronto (CA)

(21) Appl. No.: 14/586,288

(22) Filed: Dec. 30, 2014

(51) Int. Cl. G06F 3/0483; G06F 3/0488; G06T 11/60

(52) U.S. Cl. CPC G06F 3/0483; G06T 11/60; G06F 3/0488

(57) ABSTRACT

A method and system for providing an expression randomizer for selected portions of e-book content rendered on a device display screen, with an interface therefore. The method, executed in a processor of the device, comprises receiving, at the touch screen display, a selection of an expression within the content of e-book, the expression comprising a plurality of characters; generating a randomized version of plurality of characters of the expression; receiving an action, at the touch screen display, to create a re-arranged version from the randomized version by re-arranging a sequence at least one character within the randomized version; and presenting the selected expression and the re-arranged version within a digitally repaginated content page of the e-book at the touch screen display.

### TECHNICAL FIELD

Examples described herein relate to a system and method for operating a computing device in providing a randomizer functionality and memorization interface within an e-book.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from, or coupled to, but distinct from the electronic personal display itself. Some examples of electronic personal displays include mobile digital devices/tablet computers and electronic readers (e-readers) such (e.g., Apple iPad®, Microsoft® Surface™ Samsung Galaxy Tab® and the like), handheld multimedia smart phones (e.g., Apple iPhone®, Samsung Galaxy S®, and the like), and handheld electronic readers (e.g., Amazon Kindle®, Barnes and Noble Nook®, Kobo Aura HD, Kobo Aura H2O, Kobo GLO and the like).

Some electronic personal display devices are purpose built devices designed to perform especially well at displaying digitally stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

Electronic personal displays are among numerous kinds of consumer devices that can receive services and utilize resources across a network service. Such devices can operate applications or provide other functionality that links a device to a particular account of a specific service. For example, the electronic reader (e-reader) devices typically link to an online bookstore, and media playback devices often include applications that enable the user to access an online media electronic library (or e-library). in this context, the user accounts can enable the user to receive the full benefit and functionality of the device.

Yet further, such devices may incorporate a touch screen display having integrated touch sensors and touch sensing functionality, whereby user input commands via touch-based gestures are received thereon.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-book services on a computing device configured for operation in randomizing a selected content portion of an e-book stored thereon, in an embodiment.

FIG. 2 illustrates a schematic architecture of a computing device configured for operation in randomizing a selected content portion of an e-book stored thereon, according to an embodiment.

FIGS. 3a-3f illustrate example embodiments for operations related to randomizing selected content portion of an e-book stored in memory of a computing device having a touch screen display.

FIG. 4 illustrates a method for operation of a computing device for randomizing a selected content portion of an e-book stored thereon, according to an embodiment.

### DETAILED DESCRIPTION

“E-books” are a form of electronic publication content stored in digital format in a computer non-transitory memory, viewable on a computing device having display functionality. An e-book can correspond to, or mimic, the paginated format of a printed publication for viewing, such as provided by printed literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., specialized e-reading application software) to view e-books in a format that mimics the paginated printed publication. Still further, some devices (sometimes labeled as “e-readers”) can display digitally-stored content in a more reading-centric manner, while also providing, via a user input interface, the ability to manipulate that content for viewing, such as via discrete pages arranged sequentially (that is, pagination) corresponding to an intended or natural reading progression, or flow, of the content therein.

An “e-reading device”, variously referred to herein as an electronic personal display or mobile computing device, can refer to any computing device that can display or otherwise render an e-book. By way of example, an e-reading device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet computer device, an ultra-mobile computing device, or a wearable computing device with a form factor of a wearable accessory device (e.g., smart watch or bracelet, glass-wear integrated with a computing device, etc.). As another example, an e-reading device can include an e-reader device, such as a purpose-built device that is optimized for an e-reading experience (e.g., with E-ink displays).

While conventional physical paper books typically include a fixedly-configured table of contents page(s) intended to assist a user or observer to locate a desired portion or page of the book for reading, a digitally rendered e-book may be configured in other, more fluid arrangements that allow alternative ways for a user to conveniently access a particular content portion or page of the e-book.

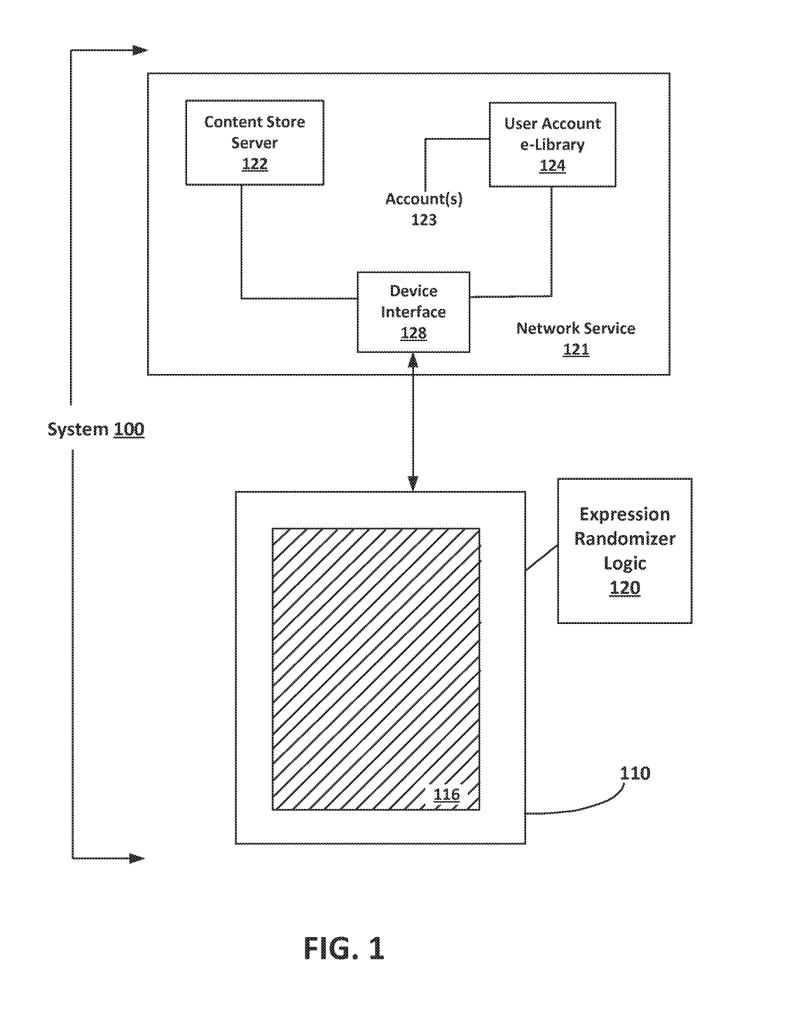

FIG. 1 illustrates a system 100 for utilizing applications and providing e-book services on a computing device configured for operation of a time-release-based e-book gifting scheme, according to an embodiment. In an example of FIG. 1, system 100 includes an electronic personal display device, shown by way of example as e-reading device 110, and a network service 121. The network service 121 can include multiple servers and other computing resources that provide various services in connection with one or more applications that are installed on the e-reading device 110. By way of example, in one implementation, the network service 121 can provide e-book services that communicate with the e-reading device 110. The e-book services provided through network service 121 can, for example, include services in which e-books are sold, shared, downloaded and/or stored. More generally, the network service 121 can provide various other content services, including content rendering services (e.g., streaming media) or other network application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can run an e-reader application that links the device to the network service 121 and enables e-books provided through the service to be viewed and consumed by way of e-reading. In another implementation, the e-reading device 110 can run a media playback or streaming application that receives files or streaming data from the network service 121. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an E-ink display.

In additional detail, the network service 121 can include a device interface 128, a content store server 122, and a user account electronic library (e-library) 124 storing e-books or digital content items. In some embodiments, content store server 122 and user account e-library may be implemented via server computing devices, as well as a server cloud computing system. Content store server 122 may be an online store for purchasing of digital content items for download there from onto a resident memory of a e-reading device 110 and/or user account e-library 124. User account e-library 124 associates the e-reading device 110 with a user having a account 123. The account 123 can also be associated with ownership of and/or accessibility to, one or more digital content items stored in content store server 122. In one embodiment, the digital content items are e-books, and the content store server 122 is an online store having e-books for purchase or other licensed use. The device interface 128 can handle requests from the e-reading device 110 with regard to services and functionality of the network service 121. The device interface 128 can utilize information provided with user account 123 in order to enable services, such as purchasing and downloading of e-books into user account e-library 124, and determining what e-books and content items providable via content store server 122 are associated with, and accessible to, user account 123. Additionally, the device interface 128 can provide the e-reading device 110 with access to the on-line content store server 122. The device interface 128 can handle input to identify content items (e.g., e-books), and further to associate content items to account 123 of the user e-library 124.

Yet further, content store server 122 and user account e-library 124 can retain metadata for individual accounts 123 to identify e-books or other digital content items that have been purchased or made available for consumption for a given account. Thus, information relating to e-books within user account e-library 124 can include metadata set in addition to substantive digital text and image content portions. The metadata set can include, for example, information such as the graphic representation of the e-book, such as including artwork- or image-based representation of a counterpart physical paper book cover, as well as summary information, author information, title, short synapse or book review, publication date and language of the e-book, and book or volume series information.

E-reading device 110, interchangeably referred to as display device 110 or computing device 110 herein, may be associated with the user account 123, and in fact multiple such display devices may be associated with a same account. As described in greater detail below, e-reading device 110 can locally store content items (e.g., e-books) that are purchased or otherwise made available to the user of the e-reading device 110 as well as to archive, in user account 124, e-books and other digital content items that have been purchased for the user account 123, but are not necessarily stored in local resident memory at display device 110.

With reference to an example depiction of FIG. 1, e-reading device 110 can include a touch screen display 116. In an embodiment, the display screen 116 is touch-sensitive, to process touch inputs including gestures (e.g., swipes). For example, the display screen 116 may be integrated with one or more touch sensors to provide a touch-sensing region on a surface of the display screen 116. For some embodiments, the one or more touch sensors may include capacitive sensors that can sense or detect a human body's capacitance as input. In the example of FIG. 1, the touch-sensing region coincides with a substantial surface area, if not all, of the display screen 116.

In some embodiments, the e-reading device 110 includes features for providing functionality related to displaying paginated content, including paginated content comprising an e-magazine or e-comic book. The e-reading device 110 can include page transitioning logic, which enables the user to transition through paginated content. The e-reading device 110 can display pages of e-books, e-magazines and e-comics, and enable the user to transition from one page state to another. In particular, an e-book can provide content that is rendered sequentially in pages, and the e-book can display page states in the form of single pages, multiple pages or portions thereof. Accordingly, a given page state can coincide with, for example, a single page, or two or more pages displayed at once. The page transitioning logic can operate to enable the user to transition from a given page state to another page state in the specific example embodiment where a given page state coincides with a single page, for instance, each page state corresponding to one page of the digitally constructed, ordered sequence of pages paginated to comprise, in one embodiment, an e-book. In some implementations, the page transitioning logic enables single page transitions, chapter transitions, or cluster transitions (multiple pages at one time).

According to some embodiments, the e-reading device 110 includes display sensor logic to detect and interpret user input or user input commands made through interaction with the touch sensors. By way of example, display sensor logic can detect a user making contact with the touch-sensing region of the display screen 116, otherwise known as a touch event. More specifically, display sensor logic can detect a touch events also referred to herein as a tap, an initial tap held in contact with display screen 116 for longer than some pre-defined threshold duration of time (otherwise known as a “long press” or a “long touch”), multiple taps performed either sequentially or generally simultaneously, swiping gesture actions made through user interaction with the touch sensing region of the display screen 116, or any combination of these gesture actions. Although referred to herein as a “touch” or a tap, it should be appreciated that in some design implementations, sufficient proximity to the screen surface, even without actual physical contact, may register a “contact” or a “touch event”. Furthermore, display sensor logic can interpret such interactions in a variety of ways. For example, each such interaction may be interpreted as a particular type of user input associated with a respective input command, execution of which may trigger a change in state of display 116.

Expression randomizer logic module 120 provides, in an embodiment, an interface tool via touch screen display 116 of display device 110, suited to academic & e-textbooks context. Expression randomizer logic module 120 includes logic providing, in part, part, a tool to aid a user in memorizing content portions of the e-book. Upon selection of an expression within the content of e-book at the display screen, where the expression comprises text or symbol characters as used in word sentences and physical equations, including combinations thereof, a randomly jumbled version of plurality of characters of the expression is generated via expression randomizer logic module 120. The selected expression and its jumbled randomized version are presented within digitally repaginated content of e-book at the display screen. Then a user at the touch screen display attempts to re-arrange the randomized version back into its original state, the result of which reflects the degree to which the original expression has been successfully memorized.

Expression randomizer logic module 120 can be implemented as software modules comprising instructions stored in a memory of a computing device, such as content store server 122 and/or display device 110. In one or more embodiments of expression randomizer logic module 120, and gifting interface logic module 125 described herein may he implemented using programmatic modules or components. A programmatic module or component may include a program, a subroutine, a portion of a program, or a software or a hardware component capable of performing one or more stated tasks or functions in conjunction with one or more processors. As used herein, a module or component can exist on a hardware component independently of other modules or components. Alternatively, a module or component can be a shared element or process of other modules, programs and hardware components.

Furthermore, the one or more embodiments of expression randomizer logic module 120 described herein may be implemented through instructions that are executable by one or more processors. These instructions may be stored on a computer-readable non-transitory medium. In particular, the numerous computing and communication devices shown with embodiments of the invention include processor(s) and various forms of computer memory, including volatile and non-volatile forms, storing data and instructions. Examples of computer-readable mediums include permanent memory storage devices, such as hard drives on personal computers or servers. Other examples of computer storage mediums include portable storage units, flash or solid-state memory (such as included on many cell phones and consumer electronic devices) and magnetic memory. Computers, terminals, network enabled devices (e.g., mobile devices such as cell phones and wearable computers) are all examples of machines and devices that utilize processors, memory, and instructions stored on computer-readable mediums. Additionally, embodiments may be implemented in the form of computer-programs, or a computer usable storage medium capable of storing such a program.

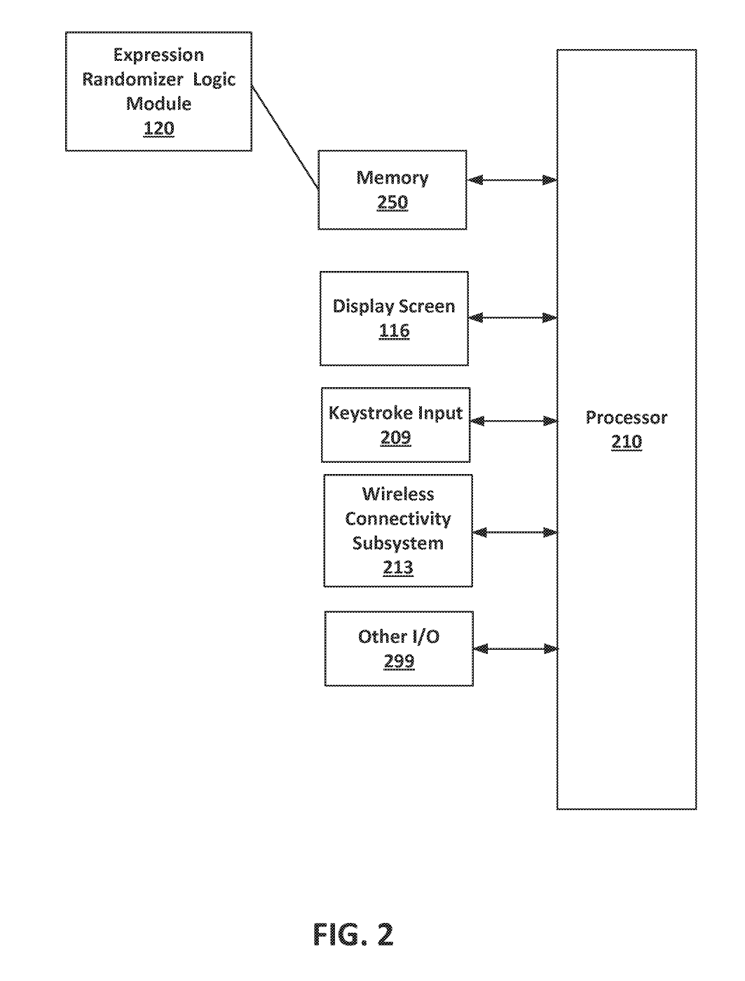

With reference now to FIG. 2, illustrated is a schematic architecture of a computing device configured for operation in randomizing a selected content portion of an e-book stored thereon, according to an embodiment.

E-reading device 110 further includes processor 210, a memory 250 storing instructions and logic pertaining at least to display sensor logic and expression randomizer logic module 120.

Processor 210 can implement functionality using the logic and instructions stored in memory 250. Additionally, in some implementations, processor 210 communicates with the network service 121 (see FIG. 1). More specifically, the e-reading device 110 can access the network service 121 to receive various kinds of resources (e.g., digital content items such as e-books, configuration files, account information), as well as to provide information (e.g., user account information, service requests etc.). For example, e-reading device 110 can receive application resources, such as e-books or media files, that the user elects to purchase or otherwise download via the network service 121. The application resources that are downloaded onto the e-reading device 110 can be stored in memory 250.

In some implementations, display 116 can correspond to, for example, a liquid crystal display (LCD) or light emitting diode (LED) display that illuminates in order to provide content generated from processor 210. In some implementations, display 116 can be touch-sensitive, For example, in some embodiments, one or more of the touch sensor components may be integrated with display 116. In other embodiments, the touch sensor components may be provided (e.g., as a layer) above or below display 116 such that individual touch sensor components track different regions of display 116. Further, in some variations, display 116 can correspond to an electronic paper type display, which mimics conventional paper in the manner in which content is displayed. Examples of such display technologies include electrophoretic displays, electro-wetting displays, and electro-fluidic displays.

Processor 210 can receive input from various sources, including touch sensor components at display 116, keystroke input 208 such as from a virtual or rendered keyboard, and other input mechanisms 299 (e.g., buttons, mouse, microphone, etc.). With reference to examples described herein, processor 210 can respond to input detected at the touch sensor components. In some embodiments, processor 210 responds to inputs from the touch sensor components in order to facilitate or enhance e-book activities such as generating e-book content on display 116, performing page transitions of the displayed e-book content, powering off the device 110 and/or display 116, activating a screen saver, launching or closing an application, and/or otherwise altering a state of display 116.

In some embodiments, memory 250 may store display sensor logic that monitors for user interactions detected through the touch sensor components, and further processes the user interactions as a particular input or type of input. In an alternative embodiment, display sensor logic module may be integrated with the touch sensor components. For example, the touch sensor components can be provided as a modular component that includes integrated circuits or other hardware logic, and such resources can provide some or all of display sensor logic. In variations, some or all of display sensor logic may be implemented with processor 210 (which utilizes instructions stored in memory 250), or with an alternative processing resource.

E-reading device 110 further includes wireless connectivity subsystem 213, comprising a wireless communication receiver, a transmitter, and associated components, such as one or more embedded or internal antenna elements, local oscillators, and a processing module such as a digital signal processor (DSP) (not shown). As will be apparent to those skilled in the field of communications, the particular design of wireless connectivity subsystem 213 depends on the communication network in which display device 110 is intended to operate, such as in accordance with Wi-Fi, Bluetooth, Near Field Communication (NFC) communication protocols, and the like.

Expression randomizer logic module 120 can be implemented as a software module, comprising instructions stored in memory 250, on mobile display device 110. In one implementation, the local memory 250 can include records for each e-book in the user's e-library account 124, each record include metadata of the e-books therein. The user may have the content portion of select e-books archived remotely at a computer server cloud system, so as not to reside in the local memory 250, but be provided by the network service 121 upon request or as needed.

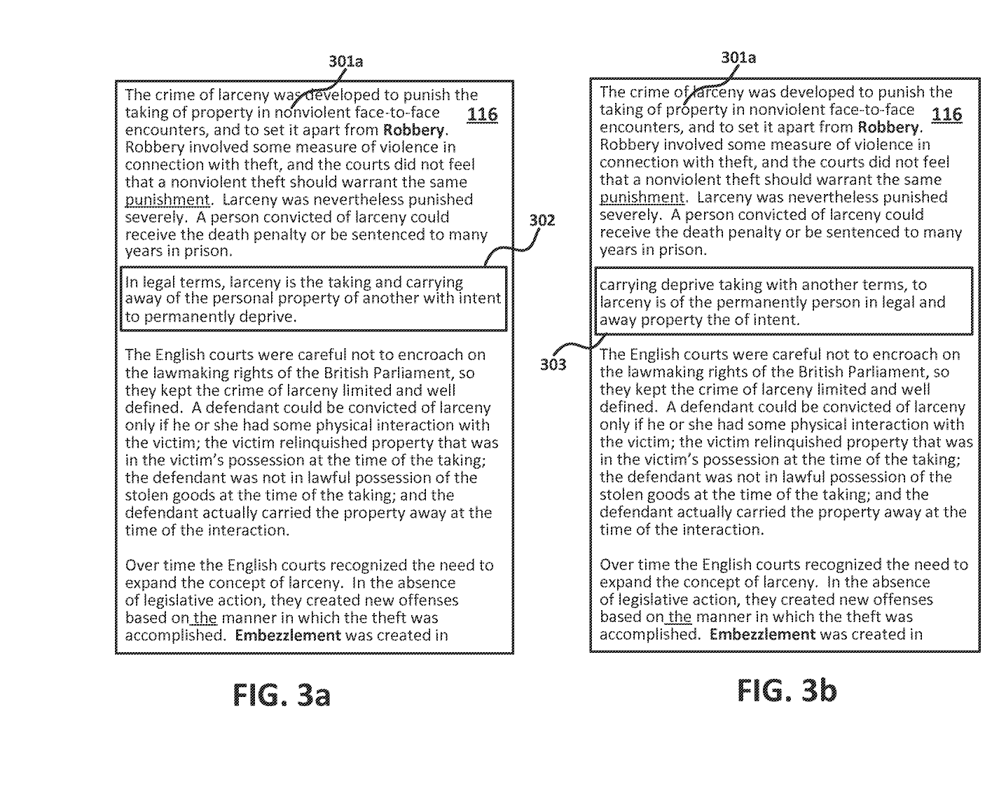

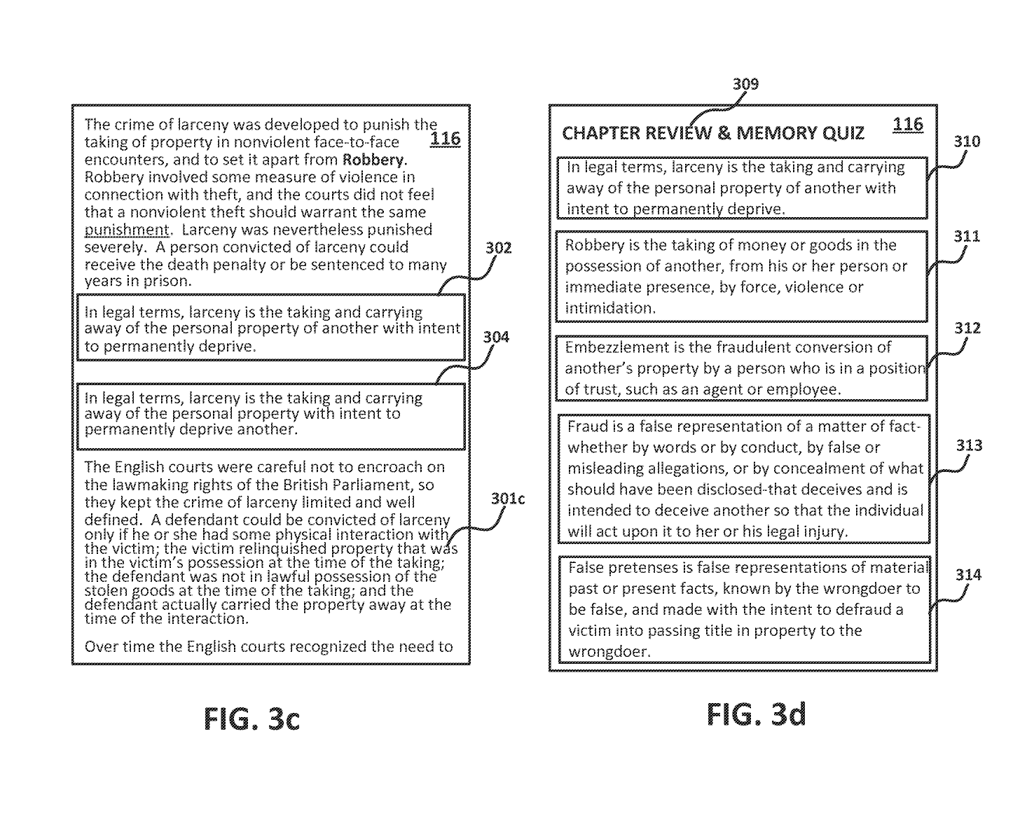

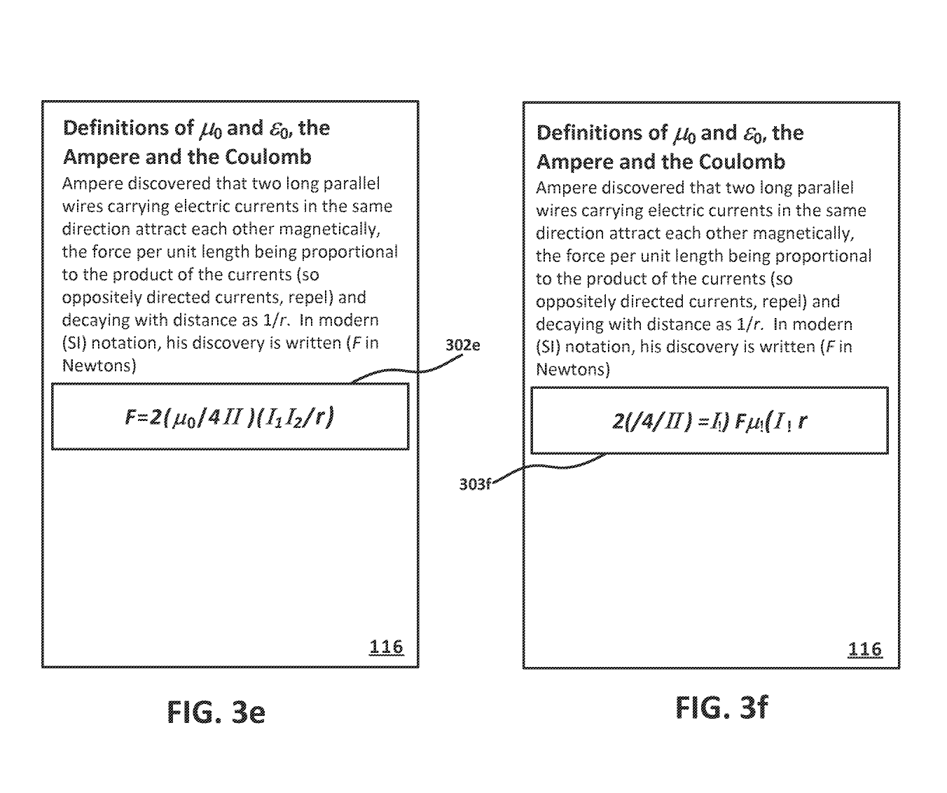

Next in reference to FIGS. 3a-3f, depicted are example embodiments of operations related to randomizing selected content portion of an e-book stored in memory of a computing device having a touch screen display. Expression randomizer logic module 120 functions, at least in part, to provide an interface, via display screen 116 of display device 110, for selecting content expressions or content portions of an e-book, randomly jumbling the character contents of the selected expressions, then testing a user's memorization of the original expression by allowing the user, at the touch screen interface, to re-assemble or revert the jumbled version back into the original state of the expression.

FIG. 3a illustrates a view of a digitally constructed page 301a of e-book content rendered within touch screen display 116 of e-reading display device 110. In this depiction, the e-book may be such as a legal textbook. Via a touch gesture action enacted upon the e-book content page 301a, the user may select, such as by highlighting, expression content portion 302 that comprises a legal definition of larceny by way of text characters grouped into the words, the words forming a sentence.

FIG. 3b shows the result of the user electing a “JUMBLE” function or command option for enactment upon expression content portion 302. The JUMBLE command may be presented such as by a drop down menu in response to the highlighting, or via a soft “button” option presented within display screen 116. In response, randomized version 303 is generated, whereby the words of original expression content portion 302 are now randomly jumbled.

Next with reference to FIG. 3c, the user may next elect to move component words of randomly jumbled content portion 303 into different relative positions there within, to create a re-arranged version 304. Movement of the component words of digitally rendered randomized version 303 may be accomplished by selecting individual words therein, then physically dragging into a different relative position, via stylus or human digit, on touch screen display 116.

Still with reference to FIG. 3c illustrated is a view 301c of the digitally constructed page 301a of the e-book within which the original expression 302 as selected and a user attempted re-arranged portion 304 to re-assemble content of jumbled portion 303 via touch screen display 116 back to original expression content portion 302. The degree to which the original expression 302 as selected and a user attempt portion 304 are identical or dissimilar reflects the user's progress or accuracy in memorizing and learning the definition of the word larceny, in the particular embodiment depicted. Once the user requests presentation of their attempt or result 304 versus original expression 302, the contents of original content page 301a may be repaginated into a view 301c, whereby ending lines of original content page are line-wrapped into a re-constructed digital page comprising a next or subsequent page in the series of content pages collectively forming the e-book content. In an embodiment, the original expression 302 may be rendered in a different visual format alongside user attempt portion 304, such as via any combination of display illumination levels, character sizes, character or highlighting colors, character font types, and pulsating character aspects.

FIG. 3d illustrates a view of a further aspect where a chapter summary or memory quiz may be presented at the end of a chapter, in the example legal textbook embodiment. A series of selectable content portions 310-314, drawn from the content covered in the legal textbook chapter, for example, may be presented whereby the user can proceed to generate randomly jumbled counterparts for re-assembling into the respective original expressions.

In another embodiment, FIG. 3e illustrates a view in an embodiment where the e-textbook chapter content is from a physics or mathematics text. Content expression 302 may be a physical or mathematical equation containing groups of symbol characters (including Greek symbols mu, pi, etc.).

Upon selecting the JUMBLE option, for instance, the depiction of FIG. 3f illustrates a view where symbols of selected equation expression 302e are changed into randomly jumbled content version 303. The user can next proceed similarly as described with regard to word re-arrangement of examples of FIGS. 3a-3d, but in this case selecting individual symbol characters of the randomly jumbled version 303f for attempted re-assembly into a state identical to selected original equation expression 302e.

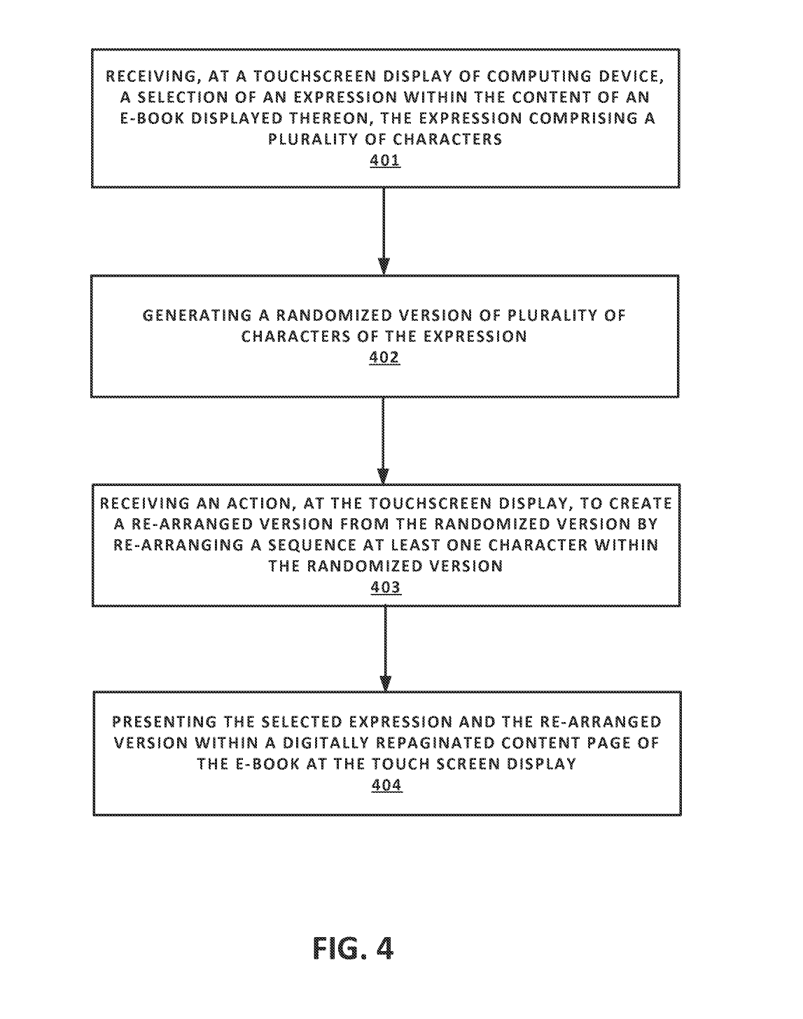

Next with reference to FIG. 4, illustrated is a method for operation for randomizing a selected content portion of an e-book stored on a computer device having a touch screen display, according to an embodiment. In describing the example of FIG. 4, reference will be made to components such as described with regard to FIGS. 1 through 3a-3f for purposes of illustrating components for performing a step or sub-step as described.

At step 401, receiving a selection of an expression 302 within the content 301 of e-book at the display screen 116, the expression 302 comprising a plurality of characters, the e-hook being displayable at the display screen 116 according to a sequence of digitally constructed pages including page 301 depicted.

At step 402, generating a randomized version 303 of plurality of characters of the expression.

At step 403, receiving an action, at the touch screen display 116, to create a re-arranged version 304 from the randomized version by re-arranging a sequence at least one character within the randomized version.

At step 404, presenting the selected expression 302 and the re-arranged version 304 within a digitally repaginated content page 301c of the e-book at the touch screen display 116.

Although illustrative embodiments have been described in detail herein with reference to the accompanying drawings, variations to specific embodiments and details are contemplated and encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method executed in a processor of a computing device, the computing device further including a touch screen display, a memory storing instructions and an e-hook having content displayable according to a series of digitally constructed pages, the method comprising:
receiving, at the touch screen display, a selection of an expression within the content of e-book, the expression comprising a plurality of characters;
generating a randomized version of plurality of characters of the expression;
receiving an action, at the touch screen display, to create a re-arranged version from the randomized version by re-arranging a sequence at least one character within the randomized version; and
presenting the selected expression and the re-arranged version within a digitally repaginated content page of the e-book at the touch screen display.

2. The method of claim 1 wherein the e-book comprises a textbook.

3. The method of claim 1 wherein at least a subset of plurality of characters of the expression comprise text characters.

4. The method of claim 3 wherein the text characters are grouped into words.

5. The method of claim 1 wherein at least a subset of plurality of characters of the expression comprise symbol characters.

6. The method of claim 5 wherein the symbol characters are arranged into one of a physical equation and a mathematical equation.

7. The method of claim 1 wherein the re-arranged version comprises a reversion to a sequence of characters of the selected expression.

8. The method of claim 7 wherein the at least one character of the randomized version is re-arranged in a sequence prior to the jumbling.

9. The method of claim 1 wherein the selected expression and the randomized version are presented in respectively different visual formats within the digitally repaginated content of the e-book at the display screen.

10. The method of claim 9 wherein the different visual formats comprise at least one of a display illumination level, a character size, a character color, a character font type, and a pulsating character aspect.

11. A computer-readable medium that stores instructions and an e-book for a computing device, the computing device including a processor and a memory storing instructions and an e-book having digital content, the instructions being executable by the processor to cause the computing device to perform operations that include:
receiving, at the touch screen display, a selection of an expression within the content of e-book, the expression comprising a plurality of characters;
generating a randomized version of plurality of characters of the expression;
receiving an action, at the touch screen display, to create a re-arranged version from the randomized version by re-arranging a sequence at least one character within the randomized version; and
presenting the selected expression and the re-arranged version within a digitally repaginated content page of the e-book at the touch screen display.

12. A computing device comprising:
a memory that stores a set of instructions and an e-book having digital content arranged in a series of digitally constructed pages;
a touch screen display; and
a processor that access the instructions in memory, the processor further configured to:
receive, at the touch screen display, a selection of an expression within the content of e-book, the expression comprising a plurality of characters;
generate a randomized version of plurality of characters of the expression;
receive an action, at the touch screen display, to create a re-arranged version from the randomized version by re-arranging a sequence at least one character within the randomized version; and
present the selected expression and the re-arranged version within a digitally repaginated content page of the e-book at the touch screen display.

13. The computing device of claim 12 wherein at least a subset of plurality of characters of the expression comprise text characters.

14. The computing device of claim 13 wherein the text characters are grouped into words.

15. The computing device of claim 12 wherein at least a subset of plurality of characters of the expression comprise symbol characters.

16. The computing device of claim 15 wherein the symbol characters are arranged into one of a physical equation and a mathematical equation.

17. The computing device of claim 12 wherein the re-arranged version comprises a reversion to a sequence of characters of the selected expression.

18. The computing device of claim 17 wherein the at least one character of the randomized version is re-arranged in a sequence prior to the jumbling.

19. The computing device of claim 12 wherein the selected expression and the randomized version are presented in respectively different visual formats within the digitally repaginated content of the e-book at the display screen.

20. The computing device of claim 19 wherein the different visual formats comprise at least one of a display illumination level, a character size, a character color, a character font type, and a pulsating character aspect.
